(19) United States
(12) Patent Application Publication
(10) Pub. No.: US 2015/0227687 A1
(43) Pub. Date: Aug. 13, 2015

(54) SYSTEM AND METHOD FOR USING GENETIC DATA TO DETERMINE INTRA-TUMOR HETEROGENEITY

(71) Applicants: Edmund A. MROZ, Chestnut Hill, MA (US); James W. ROCCO, Natick, MA (US)

(72) Inventors: Edmund A. Mroz, Chestnut Hill, MA (US); James W. Rocco, Natick, MA (US)

(21) Appl. No.: 14/432,882

(22) PCT Filed: Oct. 2, 2013
(86) PCT No.: PCT/US2013/063044

§ 371 Date: Apr. 1, 2015

Related U.S. Application Data
(60) Provisional application No. 61/710,027, filed on Oct. 5, 2012.
(60) Provisional application No. 61/772,033, filed on Mar. 4, 2013.

(51) Int. Cl. G06F 19/22

(52) U.S. Cl. CPC G06F 19/22

(57) ABSTRACT

The present invention discloses systems and methods for measuring intra-tumor heterogeneity based on genetic information of a tumor. Such systems and methods may indentify genetic information of mutation specific to the tumor, determine a mutant-allele fraction for each mutated locus, calculate mutant-allele tumor heterogeneity (MATH), and measure the distribution of mutant-allele fractions among tumor-specific mutated loci of the tumor.

### CROSS-REFERENCE TO RELATED APPLICATIONS

This application claims the benefit of U.S. provisional application 61/710,027, filed Oct. 5, 2012, and U.S. provisional application 61/772,033, filed Mar. 4, 2013, which are incorporated herein by reference in their entireties.

### STATEMENT REGARDING FEDERALLY SPONSORED RESEARCH

This invention was made with government support under Grant Nos. R01DE022087 and R21CA119591 awarded by the National Institutes of Health. The government has certain rights in the invention.

### BACKGROUND OF THE INVENTION

Cancer is believed to arise from the acquisition of multiple mutations that cooperate to transform normal cells (Hanahan D, Weinberg R A. Hallmarks of cancer: the next generation. Cell. 2011; 144:646-674.). Although all neoplastic cells within a cancer presumably arose from a common ancestor, the progeny of this common ancestor continue to evolve (Greaves M, Maley C C. Clonal evolution in cancer. Nature. 2012; 481:306-313.). Hence there may be one or multiple dominant progeny subclones, and the evolutionary distance from the progenitor and the other subclones in the cancer is variable (Carter S L, Cibulskis K, Heiman E, et al. Absolute quantification of somatic DNA alterations in human cancer. Nat Biotechnol. 2012;30:413-421). The presence of multiple progeny clones within an individual tumor is generally referred as genetic heterogeneity. Genetic heterogeneity within individual tumors is now well established (Ding L, Ellis M J, Li S, et al. Genome remodelling in a basal-like breast cancer metastasis and xenograft. Nature. 2010; 464:999-1005; Gerlinger M, Rowan A J, Horswell S, et al. Intratumor heterogeneity and branched evolution revealed by multiregion sequencing. N Engl J Med. 2012; 366:883-892; Iwasa Y, Michor F. Evolutionary dynamics of intratumor heterogeneity. PLoS One. 2011; 6:e17866; Jovanovic L, Delahunt B, McIver B, Eberhardt N L, Grebe S K. Most multifocal papillary thyroid carcinomas acquire genetic and morphotype diversity through subclonal evolution following the intra-glandular spread of the initial neoplastic clone. J. Pathol. 2008; 215:145-154; Li J, Wang K, Jensen T D, Li S, Bolund L, Wiuf C. Tumor heterogeneity in neoplasms of breast, colon, and skin. BMC Res Notes. 2010; 3:321; Maley C C, Galipeau P C, Finley J C, et al. Genetic clonal diversity predicts progression to esophageal adenocarcinoma. Nat Genet. 2006; 38:468-473; Navin N, Kendall J, Troge J, et al. Tumour evolution inferred by single-cell sequencing. Nature. 2011; 472:90-94; Park S Y, Gonen M, Kim H J, Michor F, Polyak K. Cellular and genetic diversity in the progression of in situ human breast carcinomas to an invasive phenotype. J Clin Invest. 2010; 120:636-644; Russnes H G, Navin N, Hicks J, Borresen-Dale A L. Insight into the heterogeneity of breast cancer through next-generation sequencing. J Clin Invest. 2011; 121:3810-3818; Shah S P, Morin R D, Khattra J, et al. Mutational evolution in a lobular breast tumour profiled at single nucleotide resolution. Nature. 2009; 461:809-813; Shah S P, Roth A, Goya R, et al. The clonal and mutational evolution spectrum of primary triple-negative breast cancers. Nature. 2012; 486:395-399; Xu X, Hou Y, Yin X, et al. Single-cell exome sequencing reveals single-nucleotide mutation characteristics of a kidney tumor. Cell. 2012; 148:886-895; Yachida S, Jones S, Bozic I, et al. Distant metastasis occurs late during the genetic evolution of pancreatic cancer. Nature. 2010; 467:1114-1117).

It is likely that a greater extent of genetic heterogeneity poses a risk of worse clinical outcome, as a heterogeneous tumor might be more likely to contain a subclone of cancer cells that proliferate more rapidly, are prone to metastasis, or are resistant to particular types of therapy (Hakansson L, Trope C. On the presence within tumours of clones that differ in sensitivity to cytostatic drugs. Acta Pathol Microbiol Scand A. 1974; 82:35-40; Fidler I J, Kripke M L. Metastasis results from preexisting variant cells within a malignant tumor. Science. 1977; 197:893-895; Dexter D L, Kowalski H M, Blazar B A, Fligiel Z, Vogel R, Heppner G H. Heterogeneity of tumor cells from a single mouse mammary tumor. Cancer Res. 1978; 38:3174-3181; Salk J J, Fox E J, Loeb L A. Mutational heterogeneity in human cancers: origin and consequences. Annu Rev Pathol. 2010; 5:51-75; Marusyk A, Almendro V, Polyak K. Intra-tumour heterogeneity: a looking glass for cancer? Nat Rev Cancer. 2012; 12:323-334). Until recently there had not been a simple, generally applicable measure of genetic heterogeneity suitable for use in clinical trials and practice.

A genetically heterogeneous tumor is likely to show wide variability in mutant-allele fractions within next-generation sequencing (NGS) data, with mutations in the ancestral clone at high frequencies and subclone-specific mutations at low frequencies within mixed tumor DNA.

Differences among cancer cells within a tumor, intra-tumor heterogeneity, are thought to help determine a tumor's response to therapy. A heterogeneous tumor with many different sub-populations of cancer cells may be more likely than a homogeneous tumor to contain cells that can evade therapy and thus lead to treatment failure or relapse, for example through metastasis prior to surgery, resistance to radiation therapy, or resistance to a particular chemotherapy regimen or to targeted anti-tumor agents. There has not yet been a generally applicable way to assess overall intra-tumor heterogeneity that could be used in clinical practice. Research methods to evaluate intra-tumor heterogeneity have required isolation of single cells or single nuclei from tumors, or required pre-identification of cell markers that might distinguish among cancer-cell subpopulations. These methods are either specific to particular types of cancers or would be impractical for clinical or for more routine research use.

Needed in the art are systems and methods providing straightforward ways to measure genetic intra-tumor heterogeneity, based on the results of types of DNA sequence analysis and other genomic analyses.

### SUMMARY OF THE INVENTION

The present invention overcomes the aforementioned drawbacks by providing straightforward ways to measure genetic intra-tumor heterogeneity on the basis of pre-determined genetic sequences.

In one aspect, the present invention relates to computer systems for measuring intra-tumor heterogeneity. A computer system may be programmed to obtain pre-determined genetic information of a tumor, indentify genetic information of mutation specific to the tumor and determine the mutant-allele fraction for each mutated locus. The computer system may also be programmed to calculate mutant-allele tumor heterogeneity (MATH) and measure the distribution of mutant-allele fractions among tumor-specific mutated loci of the tumor, and generate report of intra-tumor heterogeneity for the tumor.

In another aspect, the present invention relates to methods for measuring intra-tumor heterogeneity that includes obtaining pre-determined genetic information of a tumor, indentifying genetic information of mutation specific to the tumor, and determining a mutant-allele fraction for each mutated locus. The method also includes calculating a mutant-allele tumor heterogeneity (MATH), measuring a distribution of mutant-allele fractions among tumor-specific mutated loci of the tumor, and generating a report of intra-tumor heterogeneity for the tumor.

In accordance with another aspect of the present invention, a computer system for measuring intra-tumor heterogeneity that includes an input interface unit to obtain genetic information of a tumor, a processor which carries on the steps of indentifying genetic information of mutation specific to the tumor, determining the mutant-allele fraction for each mutated locus and calculating mutant-allele tumor heterogeneity (MATH) and measure the distribution of mutant-allele fractions among tumor-specific mutated loci of the tumor, and a display to generate report of intra-tumor heterogeneity for the tumor.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF THE DRAWINGS

FIG. 1 is a block diagram showing a computer system for measuring genetic intra-tumor heterogeneity in accordance with the present invention.

FIG. 2 is a flow chart setting forth the steps of a process of measuring genetic intra-tumor heterogeneity according to one aspect of the present invention.

FIG. 3 is a set of diagrams illustrating hypothetical example measurements of mutant-allele tumor heterogeneity (MATH).

FIG. 4 is a set of graphs showing mutant-allele tumor heterogeneity (MATH) measurements of three head and neck squamous cell carcinoma (HNSCC) cases.

FIG. 5 is a graph showing that the mutant-allele tumor heterogeneity (MATH) measurement is not related to mutation rate.

FIG. 6 is a graph showing as-measured MATH values as being higher in HNSCC having disruptive TP53 mutations, which typically have worse outcomes than those having non-disruptive mutations or wild-type TP53

FIG. 7a is a graph showing that the HNSCC patients with HPV-negative tumors have higher MATH values than those with HPV-positive tumors.

FIG. 7b is a table showing statistical analysis of MATH values of HPV-negative tumors from cigarette smokers, illustrating increased results with pack-years of exposure.

FIGS. 8a-8f are graphs showing the relation of as-measured mutant-allele tumor heterogeneity (MATH) values to outcome in clinically defined subsets of HNSCC, whereby FIG. 8a shows a comparison of High-MATH and Low-MATH groups for all 74 cases; FIG. 8b shows a subset with HPV-negative tumors; FIG. 8c shows a subset in which tumors had disruptive mutations in the TP53 gene, all these tumors were also HPV-negative; FIG. 8d shows a subset with documented perineural invasion; FIG. 8e shows a subset with Stage IV disease; and FIG. 8f shows a subset with N classification of 2 or 3; all these cases were Stage IV.

FIG. 9 is a graph showing the correlation of the as-measured mutant-allele tumor heterogeneity (MATH) values to outcome in HNSCC treated with chemotherapy.

FIG. 10 a graph showing MATH after removing loci beyond ±0.5 log2 units of normal copy number, versus MATH for all loci. Dashed line is line of identity.

FIG. 11 is a graph showing CNA-adjusted MATH on the basis of product of mutant-allele fraction and amplification for each locus, versus MATH. Dashed line is line of identity.

### DETAILED DESCRIPTION OF THE INVENTION

The term “genetic information”, as used herein, may refer to any suitable information relating to a tumor. For example, the genetic information may refer to genetic sequences, for example, such as DNA sequences.

The term “intra-tumor heterogeneity”, as used herein, may refer to differences among cancer cells within a tumor.

When a tumor DNA sequence of a patient is compared with that of the same patient's normal tissue, including either the entire genome or a genome subset such as protein-encoding portions called the “exome”, mutations specific to the tumor may be identified.

Modern techniques, for example, 454, Illumina, Ion Torrent, may determine DNA sequences from many individual fragments of DNA analyzed separately, typically following separately localized amplification of the starting fragments. These modern techniques may be generally limited in the specific fragments of DNA, and these techniques may not be applied to any other systems.

The term “read”, as used herein, may refer to the DNA sequence found for each individual starting fragment. For the genomic locus of each tumor-specific mutation, the number of “reads” in a tumor showing the normal sequence, which are present in the individual patient's normal tissue, and the number of reads showing a tumor-specific mutant sequence may be determined as part of the sequencing process.

The term “mutant-allele fraction”, as used herein, refers to the ratio of the number of mutant reads to the total number of reads (normal plus mutant) for that mutated locus of each tumor-specific mutation.

Usually, there may be a few dozen to a few hundred reads per mutated locus. Depending on whether the entire genome or a subset of the genome is sequenced, the number of reads per locus and the type of tumor, there may be up to one hundred or more tumor-specific mutated loci found in a single tumor.

The present invention generally relates to systems and methods of using such systems for measuring intra-tumor heterogeneity. As the present invention utilizes the heterogeneity present in an individual tumor having no need of pre-identification markers to differentiate among cancer cell populations, the systems and methods of using such systems in the present invention may be applicable to all types of tumors.

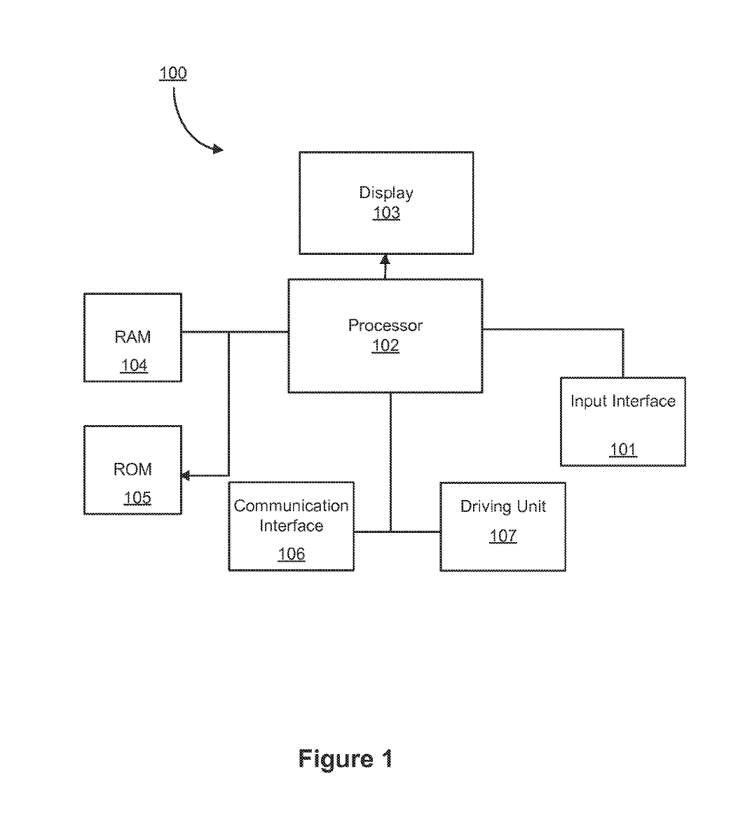

Referring to FIG. 1, an exemplary computer system for measuring genetic intra-tumor heterogeneity consistent with the disclosed embodiments is illustrated. As shown in FIG. 1, a computer system 100 for measuring genetic intra-tumor heterogeneity may include an input interface unit 101, a processor 102, a display device 103, a random access memory (RAM) unit 104, a read-only memory (ROM) unit 105, a communication interface 106, and a driving unit 107. Other components may be added and certain devices may be removed without departing from the principles of the disclosed embodiments.

Through the input interface unit 101, pre-determined genetic information of a tumor may be entered. The pre-determined genetic information of a tumor may include any suitable information relating to the tumor. In one embodiment, the pre-determined genetic information of a tumor may include a genetic sequence, for example, a DNA sequence.

In one configuration, the present invention may apply tumor DNA sequences which are directly extracted from tumor tissues. In another configuration, the present invention may also use tumor DNA sequences which are extracted from any other suitable sources such as blood plasma.

In this example, the DNA sequence of a tumor may be obtained from next-generation sequencing (NGS). For this purpose, the input interface unit 101 may include any suitable data input means as understood by a person having ordinary skill in the art. For example, the input interface unit 101 may include any appropriate input device, one or more mass storage devices for storing data, for example, magnetic, magneto optical disks, or optical disks, another device, for example, a mobile telephone, a personal digital assistant (PDA), a mobile audio or video player, a game console, a Global Positioning System (GPS) receiver, or a portable storage device (for example, a universal serial bus (USB) flash drive), to name just a few. The input interface unit 101 may include a CD-ROM, a CD/DVD drive, a flash memory device of a flash drive or a thumb drive, a floppy disk, a zip disk, a memory card, or a hard drive. The input interface unit 101 may also include any portable media storage devices. Further, in one specific configuration, the pre-determined sequences of a tumor may be input to the computer system via other means of communications, for example, computer networks or other wireless communication networks.

After pre-determined genetic sequences of a tumor are entered, the processor 102 in the computer system may analyze and process the sequences, conduct the measurement of intra-tumor heterogeneity, and generate a report for the resulting intra-tumor heterogeneity. For this purpose, the processor 102 may operate under the instruction of a non-transitory computer-readable program or media. A computer-readable program or media for operating a processor is well known to a person having ordinary skill in the art. Processors suitable for the execution of a computer program include, by way of example, both general and special purpose microprocessors, and any one or more processors of any kind of digital computer. The processor 102 may include any appropriate type of graphic processing unit (GPU), general-purpose microprocessor, digital signal processor (DSP) or microcontroller, an application specific integrated circuit (ASIC), and the like. The processor 102 may execute sequences of computer program instructions to perform various processes associated with the MATH measurement as discussed above and following hereafter.

Generally, a processor will receive instructions and data from a read only memory (ROM) or a random access memory (RAM) or both. The essential elements of a computer are a processor for performing actions in accordance with instructions and one or more memory devices for storing instructions and data. In one embodiment of the present invention, the computer program instructions for the measurement of distribution center may be loaded into RAM 104 for execution by the processor 102 from the read-only memory (ROM) 105. Devices suitable for storing computer program instructions and data may also include all forms of non-volatile memory, media, and memory devices, including by way of example semiconductor memory devices, for example, EPROM, EEPROM, and flash memory devices; magnetic disks, for example, internal hard disks or removable disks; magneto optical disks; and CD ROM and DVD-ROM disks.

In one specific configuration, to determine intra-tumor heterogeneity, the processor 102 may undertake the steps of indentifying DNA sequences of mutation specific to the tumor and determining a mutant-allele fraction for each mutated locus. The processor 102 may also calculate mutant-allele tumor heterogeneity (MATH) values and measure the distribution of mutant-allele fractions among tumor-specific mutated loci of the tumor.

In one configuration of the present invention, the processor 102 may apply the distribution of mutant-allele fractions among tumor-specific mutated loci to determine the intra-tumor genomic/genetic heterogeneity of an individual tumor. Specifically, the processor 102 may use a percentage ratio of the median absolute deviation (MAD) to the median of each tumor's distribution of mutant-allele fractions among tumor-specific mutated loci to provide a measure of this type of intra-tumor heterogeneity as shown in Equation 1:

MATH=100*MAD/median (1);

wherein MATH means mutant-allele tumor heterogeneity, MAD means median absolute deviation showing the measurement of distribution width, and median means the median of the mutant-allele fractions showing the measurement of distribution center.

In another configuration of the present invention, the processor may apply other means of measurements for the distribution of mutant-allele fractions. For example, in addition to MAD, any other suitable means for measuring the width of the distribution of mutant-allele fractions may be applied in the present invention. The additional suitable means may include standard deviation, range, average absolute deviation, interquartile range, others. The additional suitable means may also include any alternative methods to MAD as enclosed in Rousseeuw and Croux (Rousseeuw P. J. and Croux C. Alternatives to the Median Absolute Deviation. Journal of the American Statistical Association. 1993; 88:1273-1283). Similarly, any other suitable means for measuring the center of the distribution of mutant-allele fractions may be applied in the present invention. The additional suitable means may include mean or various weighted means and others.

After the determination of intra-tumor heterogeneity by the processor 102, a report of intra-tumor heterogeneity for the tumor is generated and can be communicated, for example, in display 103 or other communications mediums, including written reports. The display 103 may be any suitable display. For the present computer system, the display 103 may be a flat display such as a liquid crystal display (LCD). Further, a LCD display 103 may also be touch-sensitive, that is, a touch-screen. The display 103 may also be a display such as a cathode-ray tube (CRT) display or a flat panel display.

The communication interface 106 may provide communication connections such that the pre-determined sequences may be obtained remotely and/or through communication with other systems through computer networks or other wireless communication networks via various communication protocols, such as transmission control protocol/internet protocol (TCP/IP), hyper text transfer protocol (HTTP), and the like.

Further, the driving unit 107 may include any appropriate driving circuitry to drive various devices, such as an optical device and/or a display device, and the like.

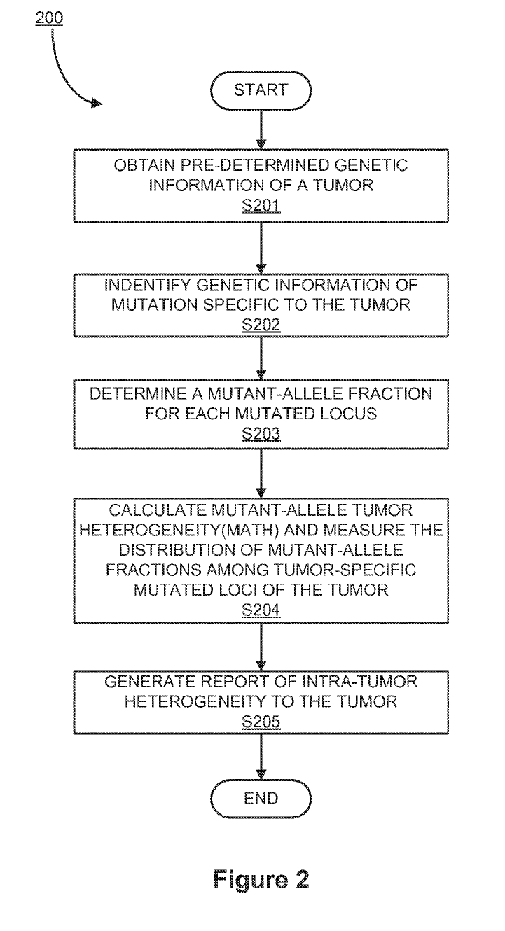

In one configuration, the present invention relates to methods of measuring intra-tumor heterogeneity using pre-determined sequences. The methods of measuring intra-tumor heterogeneity may be conducted by using the computer system 100 as shown in FIG. 1 or other systems. FIG. 2 provides a flow chart setting forth exemplary steps of an exemplary method 200 of measuring intra-tumor heterogeneity according to one aspect of the present invention. As shown in FIG. 2, pre-determined genetic information of a tumor is initially obtained (S201).

The pre-determined genetic information of a tumor may include any suitable information relating to the tumor. In one aspect of the invention, the pre-determined sequence of a tumor may include a genetic sequence, for example, a DNA sequence. In one specific aspect of the invention, the DNA sequence of a tumor may be obtained from next-generation sequencing (NGS). As NGS is expected to become increasingly affordable and widely used in cancer research and in clinical oncology, the methods of the present invention may provide a generally applicable and quantitative measure of intra-tumor heterogeneity.

As shown in FIG. 2, after pre-determined genetic information of a tumor is obtained, genetic information, for example, DNA sequence of mutation specific to the tumor is identified (S202). Mutations specific to the tumor may be identified by comparing the DNA sequence of a patient's tumor with those of the same patient's normal tissue. The DNA sequence may include the entire genome or a genome subset such as protein-encoding portions called the “exome”.

In one aspect of the invention, as modern techniques, for example, 454, Illumina, Ion Torrent, may determine DNA sequences from many individual fragments of DNA analyzed separately typically following localized amplification of the starting fragments, the number of “reads” in a tumor showing the normal sequence as present in the individual patient's normal tissue and the number of reads showing a tumor-specific mutant sequence may be determined as part of the sequencing process, for example, from next-generation sequencing (NGS).

Returning to FIG. 2, after the identification of genetic information of mutation specific to the tumor, the mutant-allele fraction for each mutated locus is determined (S203). In one aspect of the present invention, there may be a few dozen to a few hundred reads per mutated locus. In another aspect, depending on whether the entire genome or a subset of the genome is sequenced, depending on number of reads per locus, and depending on the type of tumor, there may be up to one hundred or more tumor-specific mutated loci found in a single tumor. In one configuration, the mutant-allele fraction for each mutated locus may be determined from next-generation sequencing (NGS).

As shown in FIG. 2, after the determination of the mutant-allele fraction for each mutated locus, mutant-allele tumor heterogeneity (MATH) of the tumor is calculated and the distribution of mutant-allele fractions among tumor-specific mutated loci is measured (S204). The MATH value of the tumor and the distribution of mutant-allele fractions among tumor-specific mutated loci may be determined by using Equation 1. For each tumor, its mutant-allele tumor heterogeneity (MATH) may be calculated as the percentage ratio of the width to the center of its distribution of mutant-allele fractions among tumor-specific mutated loci. The ratio in Equation 1 takes into account the tendency of this distribution to be both wider and centered at a lower value in a heterogeneous compared with a homogeneous tumor. The present method may thus help correct the errors from genomically normal cells within a tumor sample.

In another configuration of the present invention, any other means of measurements may be applied for measuring distribution of mutant-allele fractions and for determining intra-tumor heterogeneity. For example, in addition to MAD in Equation 1, any other suitable means for measuring the width of the distribution of mutant-allele fractions may be applied in the present invention. The additional suitable means for measuring the distribution width may include standard deviation, range, average absolute deviation, interquartile range, others. The additional suitable means may also include any alternative methods to MAD as enclosed in Rousseeuw and Croux (Rousseeuw P. J. and Croux C. Alternatives to the Median Absolute Deviation. Journal of the American Statistical Association. 1993; 88:1273-1283). Similarly, any other suitable means for measuring the center of the distribution of mutant-allele fractions may be applied in the present invention. The additional suitable means may include mean or various weighted means and others.

Further, to estimate the error inherent in calculating MATH values from NGS, which involves sampling among loci and between reference and mutant alleles, for each tumor, a method of bootstrapping re-sampling may be undertaken from all sequence reads at its mutated loci (median, 12600 reads per tumor). The standard deviation of a tumor's MATH values among 100 bootstrapping samples may typically be 4 units. As a method of evaluating sampling errors in MATH values, bootstrapping re-sampling may estimate the inherent error due to sampling of DNA fragments from different loci during next-gen sequencing, and sampling between mutant and reference alleles at each locus. A typical procedure for standard bootstrapping may include the following steps:
1) Make a list of all original sequencing reads at each tumor-specific mutated locus, with the locus and its mutant/reference status noted for each read. This might include 150 reads per locus average at 100 mutated loci, for a list of 15,000 reads.
2) Do the following steps of a)-b) for 100 or more times:
   a) Randomly sample from that original list, with replacement, until a re-sampled list equal in length to the original is obtained. Thus a read in the original list might not appear at all, might appear once, or might appear more than once in the re-sampled list. In this specific example, the re-sampled list would include 15,000 reads.
   b) Calculate the mutant-allele fraction for each locus in the re-sampled list, and then use those values to calculate MAD, median, and MATH for the re-sampled list. The re-sampled MATH value is stored.
3) Take the 100 or more re-sampled MATH values, and calculate their standard deviation or another measure of their reproducibility.

As some mutated loci in a tumor may be typically shared by most or all of its cancer cells, the cancer cells may have a high mutant-allele fraction. In a heterogeneous tumor, mutated loci restricted to one or a few genomically distinct cancer-cell populations may have a lower mutant-allele fraction than mutated loci shared by most or all cancer cells in the tumor. Therefore, the increasing numbers of cancer-cell populations may lead to a wider distribution of mutant-allele fractions among tumor-specific loci, for example, larger standard deviation, SD, or median absolute deviation, MAD. The increasing numbers of cancer-cell populations may also lower the center of the distribution of mutant-allele fractions among those loci, for example, lower mean or median mutant-allele fraction. As shown in Equation 1, a ratio of the width to the center of the distribution of mutant-allele fractions among tumor-specific mutated loci in an individual tumor may thus provide a measure of the underlying genomic/genetic heterogeneity among the cancer-cell populations in that tumor. This ratio of Equation 1 may also provide a correction for genomically normal cells within the tumor sample, as multiplicative correction factors using normal versus cancer-cell numbers to correct observed mutant-allele fractions for the presence of normal cells to provide cancer-cell-specific mutant-allele fractions will appear in both the numerator and in the denominator of that ratio. The present method, thus, will cancel the errors from the presence of normal cells.

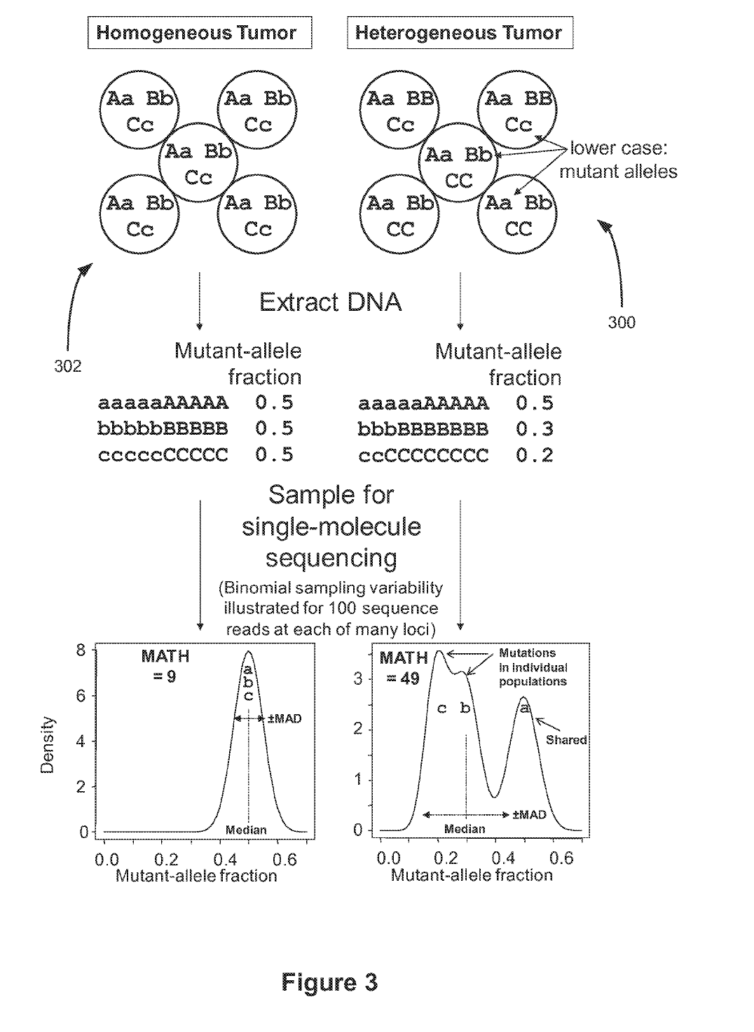

In one aspect of the present invention, the intra-tumor heterogeneity may be determined solely by measuring the distribution of mutant-allele fractions among tumor-specific mutated loci and MATH values. FIG. 3 shows an example of measuring MATH by using Equation 1. As shown in FIG. 3, in a heterogeneous tumor having genomically distinct cell populations, the mutant-allele fractions of mutations restricted to individual populations will be lower than those of shared mutations. Thus, for a heterogeneous tumor 300 the as-measured distribution of mutant-allele fractions among loci appears to be wider and centered at a lower fraction than that for a homogeneous tumor 302, demonstrating the intra-tumor heterogeneity.

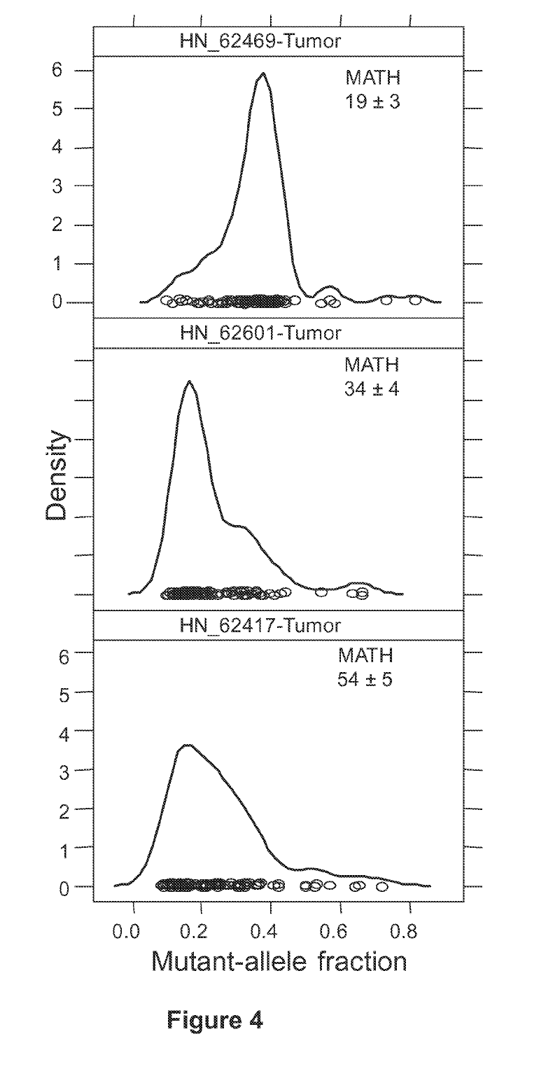

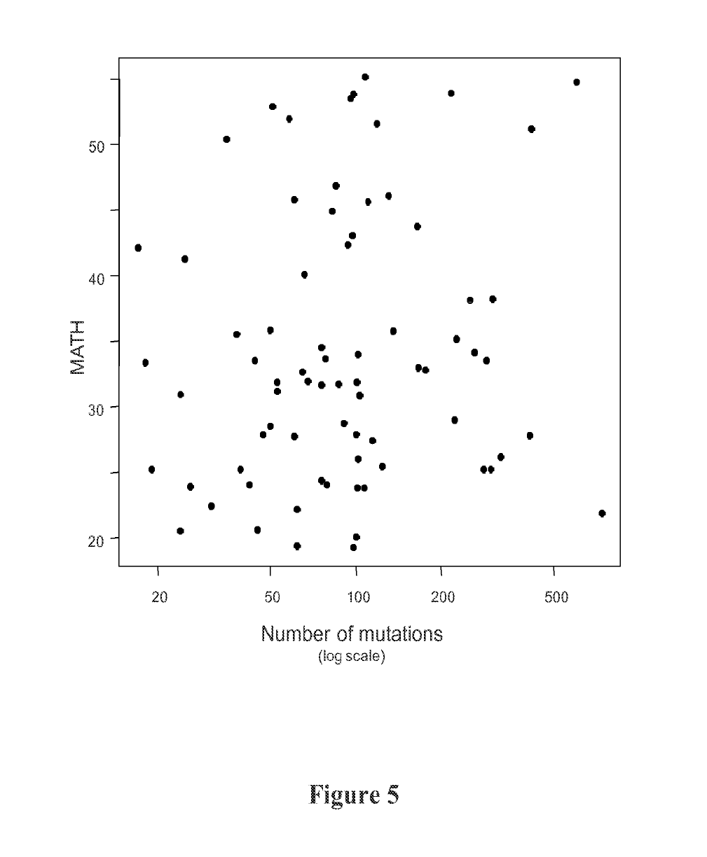

In one configuration, the present method of measuring MATH values and the distributions of their mutant-allele fractions for intra-tumor heterogeneity may not be dependent on either the numbers of mutated loci or mutation rates. FIG. 4 shows MATH measurements of three head and neck squamous cell carcinoma (HNSCC) cases. Although the numbers of mutated loci were similar for these 3 tumors (top to bottom: 98, 102, 96 loci), the distributions of their mutant-allele fractions and their MATH values were substantially different. Further, FIG. 5 demonstrates exemplary cases where a tumor's MATH value was not significantly related to its number of mutations, often used as a measure of mutation rate.

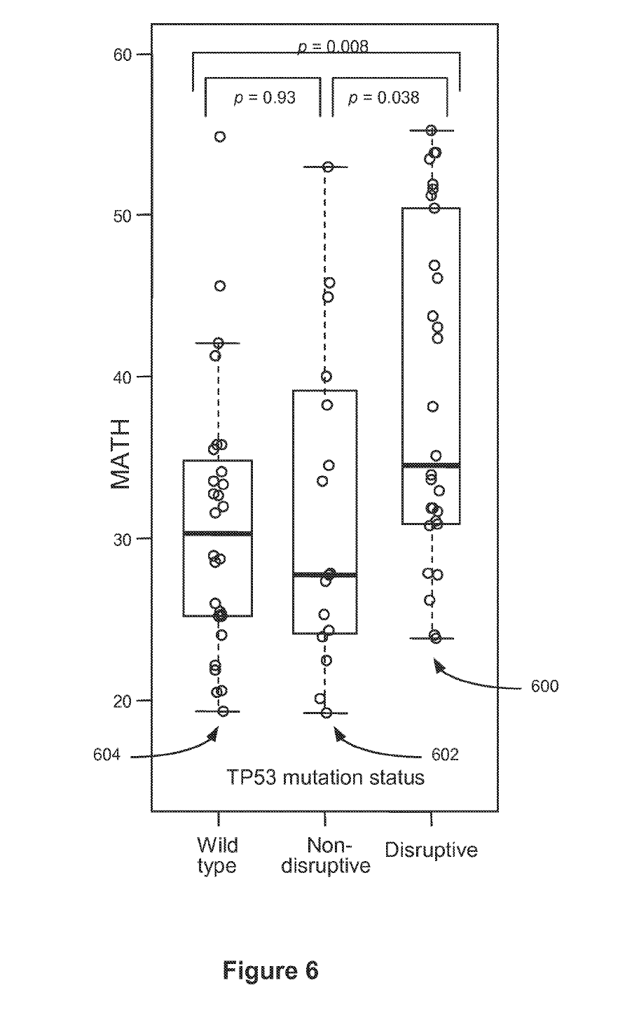

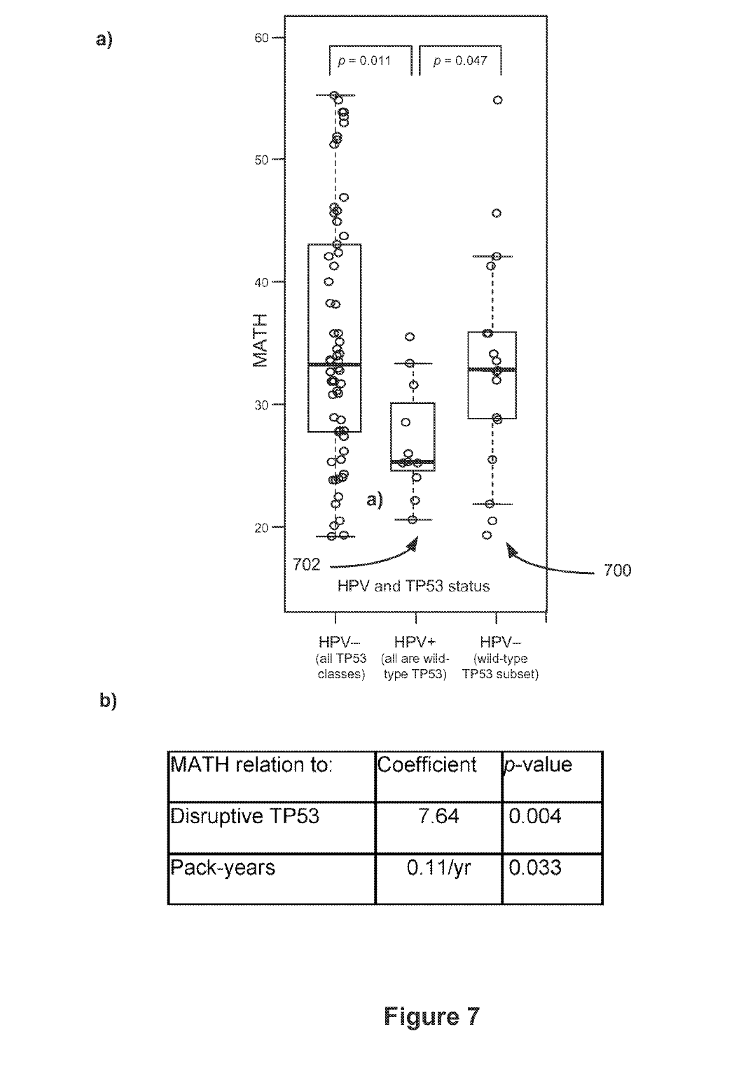

Further, the present method of measuring MATH values and the distributions of their mutant-allele fractions for intra-tumor heterogeneity are consistent with the outcomes and the clinical results. FIG. 6 shows exemplary cases where the as-measured MATH values were higher in HNSCC having disruptive TP53 mutations 600, which typically have worse outcomes than those having non-disruptive mutations 602 or wild-type TP53 604. FIG. 7 demonstrates exemplary cases where the HNSCC patients with HPV-negative tumors had higher MATH values than those with HPV-positive tumors. HPV-negative HNSCC typically have worse outcomes than HPV-positive HNSCC. Further, the HPV-positive and HPV-negative HNSCC patients showed different as-measured MATH values even when analysis was restricted to cases having wild-type TP53 700, 702. As shown in FIG. 7b, MATH values of HPV-negative tumors from 51 cigarette smokers increased with pack-years of exposure by 1.1 units per 10 pack-years, consistent with the clinical result of 1% increased risk of recurrence following treatment for each pack-year of prior cigarette exposure.

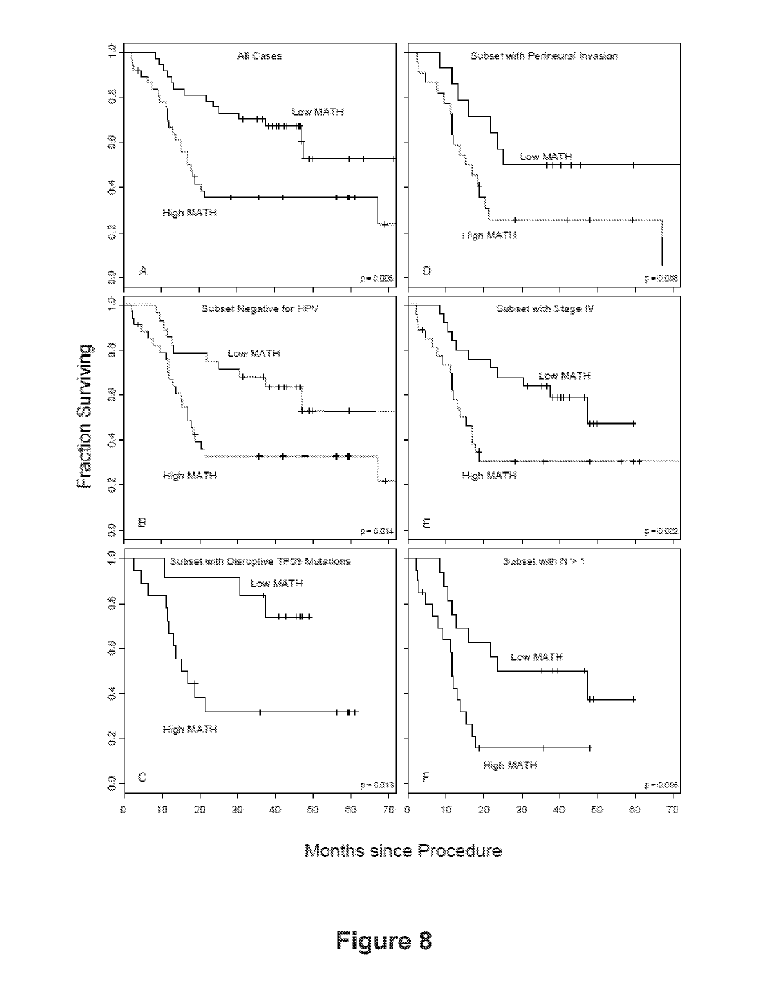

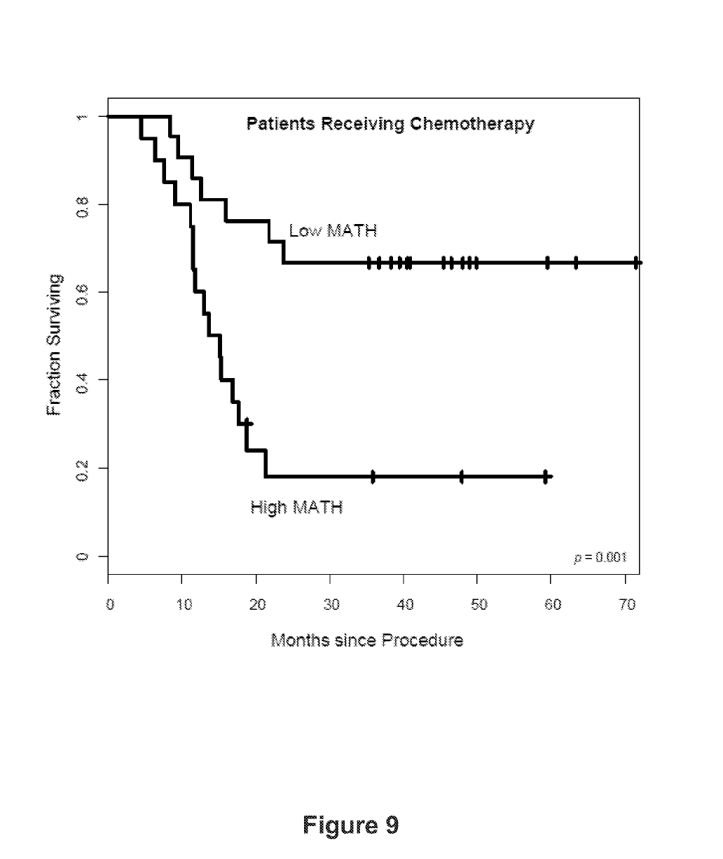

Further, the present method of measuring MATH values and the distributions of the mutant-allele fractions for intra-tumor heterogeneity produced results consistent with those of overall survival. For example, as shown in FIGS. 8-9 and Table 1 (below), the as-measured MATH values and the distributions of the mutant-allele fractions may provide direct evidence that high genetic heterogeneity is related to shorter overall survival. These results were also consistent with the long-standing hypothesis that high genetic heterogeneity is a risk factor for worse outcome in cancer (Hakansson L, Trope C. On the presence within tumours of clones that differ in sensitivity to cytostatic drugs. Acta Pathol Microbiol Scand A. 1974; 82:35-40; Fidler I J, Kripke M L. Metastasis results from preexisting variant cells within a malignant tumor. Science. 1977; 197:893-895; Dexter DL, Kowalski H M, Blazar B A, Fligiel Z, Vogel R, Heppner G H. Heterogeneity of tumor cells from a single mouse mammary tumor. Cancer Res. 1978; 38:3174-3181; Salk J J, Fox E J, Loeb L A. Mutational heterogeneity in human cancers: origin and consequences. Annu Rev Pathol. 2010; 5:51-75; Marusyk A, Almendro V, Polyak K. Intra-tumour heterogeneity: a looking glass for cancer? Nat Rev Cancer. 2012; 12:323-334.).

Further, as shown in Table 1 and FIGS. 8-9, the as-measured MATH values not only were significantly related to outcome on their own, but also distinguished subgroups at higher risk within the already high-risk groups defined by HPV or TP53 status, by N classification or TNM stage, or by the presence of perineural invasion. The as-measured MATH values were not significantly related to N classification, the best single prognostic variable in this data set, or to TNM stage. The as-measured MATH values were related to outcome both when cases were stratified by N classification or stage and when analysis was restricted to the subsets of high-N and high-stage cases. Therefore, MATH in the present invention may be used as an independent prognostic marker.

TABLE 1
Relation of MATH to Overall Survival

| | | Relation to Overall Survival | | |
|---|---|---|---|---|
| | deaths/ | Hazard | | |
| Analysis | cases | Ratio | 95% CI | p-value |
| Univariate | 39/74 | 1.047/unit | (1.017-1.078) | 0.002 |
| Stratified by HPV status | 39/73 | 1.051/unit | (1.018-1.084) | 0.002 |
| Univariate; HPV-negative subset | 35/62 | 1.050/unit | (1.017-1.083) | 0.003 |
| Stratified by TP53 mutation status | 39/74 | 1.048/unit | (1.016-1.080) | 0.003 |
| Univariate; disruptive TP53 subset | 15/30 | 1.088/unit | (1.031-1.15) | 0.002 |
| Stratified by PNI status | 36/67 | 1.035/unit | (1.002-1.068) | 0.035 |
| Univariate; subset with PNI | 25/36 | 1.047/unit | (1.006-1.089) | 0.023 |
| Stratified by Stage (II, III vs IV) | 36/70 | 1.047/unit | (1.015-1.081) | 0.004 |
| Univariate; subset with Stage IV | 29/52 | 1.059/unit | (1.020-1.10) | 0.003 |
| Stratified by N classification (0, 1 vs. 2, 3) | 36/70 | 1.048/unit | (1.016-1.080) | 0.003 |
| Univariate; subset with N > 1 | 25/36 | 1.056/unit | (1.016-1.096) | 0.005 |
| Multivariate (based on variables significantly related | 33/63 | | | 4 × 10⁻⁶ |
| to outcome in univariate analyses) | | | | |
| MATH | | 1.043/unit | (1.008-1.080) | 0.017 |
| Age | | 0.946/yr | (0.910-0.982) | 0.003 |
| N > 1 | | 4.92^{§} | (2.18-11.1) | 0.0001 |
| PNI | | 2.49 | (1.15-5.39) | 0.021 |
| Univariate; cases not involving chemotherapy | 13/30 | 1.00/unit | (0.945-1.062) | 0.96 |
| Univariate; cases involving chemotherapy | 23/41 | 1.061/unit | (1.022-1.10) | 0.002 |

Results of Cox proportional hazards analysis on relations of MATH to overall survival of patients with tumor exome sequencing results reported by Stransky et al (Stransky N, Egloff A M, Tward A D, et al. The mutational landscape of head and neck squamous cell carcinoma. Science. 2011; 333: 1157-1160). Each analysis was performed on all cases having values for the variable(s) of interest, with the number of cases and of deaths shown. Hazard ratios are for MATH unless otherwise noted. MATH and Age were analyzed as continuous variables, so results for those variables are reported as multiplicative change in hazard per unit increase in MATH value or per year of age.
^{§}Evidence of non-proportional hazards for N; p = 0.048 in chi-square test for trend of coefficient of N with time. Relations of the other 3 variables to overall survival were similar in analysis stratified by N to allow for this non-proportionality; in that stratified analysis, global chi-square test had p = 0.96.

Returning to FIG. 2, during calculation of MATH and measurement of distribution of mutant-allele fractions, additional information may be considered on the amplification or loss of specific genomic loci relative to the usual 2 copies per autosomal locus per cell, e.g., copy-number alteration (CNA). The sources for information on amplification or loss may comprise DNA sequence data, comparative genomic hybridization (CGH), analysis of microarrays that report single-nucleotide polymorphisms (SNPs), or any other suitable methods. The additional information may also be derived from normal cells within the tumor rather than from cancer cells within the tumor, as tumors often contain genomically normal cells in addition to mutation-bearing cancer cells.

In one aspect, the present invention may additionally use information on CNA both for loci having tumor-specific mutations and for loci without mutations that change the DNA sequence from normal, optionally along with information about the ratio of normal-cell to cancer-cell numbers or about the ratio of normal-cell to cancer-cell DNA (overall, or at specific genomic loci) in an individual tumor sample. In one specific configuration, the present invention may use information on CNA to restrict the set of tumor-specific mutated loci included during the calculation of MATH values. Some loci of substantial CNA with very high or very low mutant-allele frequencies do not well represent the fraction of cancer cells in the tumor having mutation. Therefore, loci having CNA beyond some pre-specified limit, for example, beyond 0.5 log2 units from normal genomic copy number, may be omitted before MATH values are calculated for the remaining loci as above. This pre-specified cutoff limit may be optionally set on the basis of available information about normal-cell numbers or normal-cell DNA present in the tumor sample.

In another specific aspect of the present invention, the observed mutant-allele fraction of each locus by the CNA of the locus may be considered before MATH is calculated using the method shown in FIG. 2. While the raw observed mutant-allele fractions are based on numbers of copies of DNA, which may vary from locus to locus, these CNA-weighted fractions, having one half of the average number of mutant copies of locus per cell in the tumor sample, may correct the errors from different numbers of DNA copies per locus. Thus, the present method may provide a reliable measurement for intra-tumor heterogeneity by MATH calculation.

In another specific embodiment of the present invention, CNA data and optionally data on normal vs. cancer-cell numbers in the tumor sample may be used to obtain a measurement of intra-tumor heterogeneity. The heterogeneity of CNA among some or all genomic loci may be used as a measurement of intra-tumor heterogeneity. For example, the mean-square CNA among all bases available in a tumor sample, and the number of genomic segments having CNA beyond pre-specified magnitudes, may provide measurements of intra-tumor heterogeneity.

In one configuration of the present invention, MATH may implicitly include CNA in its measure of intratumor heterogeneity, through the influence of CNA on mutant-allele fractions. As a ratio of the width to the center of the distribution of mutant-allele fractions, MATH corrects for normal cells (“impurity”) present along with cancer cells in a tumor sample.

Equation 2 shows an exemplified formula of the mutant-allele fraction at an autosomal locus in a heterogeneous tumor with N genetically distinct cell populations, in which MATH incorporates CNA. If mᵢⱼ is the number of mutant copies of locus i per cell in population j, cᵢⱼ is the corresponding total number of copies (mutant and reference) of the locus per cell in population j, and pᵢ is the fraction of all cells that are members of population j, then the mutant-allele fraction fᵢ at locus i is:

$${f}_{i} = {\sum }_{j = 1}^{N} {m}_{ij} {p}_{j} / {\sum }_{j = 1}^{N} {c}_{ij} {p}_{j} = \frac{1}{2 {a}_{i}} {\sum }_{j = 1}^{N} {m}_{ij} {p}_{j} \qquad ( 2 )$$

where the sum is over all cell populations and aᵢ is the amplification of locus i (ratio to diploid) in the sample. Each mutant-allele fraction used to calculate MATH thus incorporates CNA, with the number of mutant copies in each cell scaled by the overall amplification of the locus in the tumor. Alternatively, if there is information on locus amplification, each mutant-allele fraction could be multiplied by its amplification aᵢ, with a result equal to ½ of the mean mutant-copy number of the locus per cell.

MATH is a ratio of the width to the center of the distribution of mutant allele fractions among tumor-specific mutated loci (100*MAD/median). If the same correction for normal cells in a tumor appears in both the numerator and the denominator, the correction cancels in the ratio so that MATH in the whole tumor is the same as MATH in just the cancer cells. Correction for normal cells is the motivation for use of this ratio rather than the width of the distribution alone as a measure of intratumor genetic heterogeneity.

A first-order correction for normal cells is used to correct for cell numbers. If population N is normal cells, the multiplicative correction factor for the “impurity” provided by normal cells is 1/(1−p_{N}) for each cancer-cell-population fraction and thus for all mutant-allele fractions (Equation 2). This correction for cell numbers is identical for all loci and cancels in the calculation of MATH.

In one configuration, the above correction for normal-cell numbers may also be the correction for normal-cell DNA at loci without CNA. For example, with a median of 92 mutated loci per tumor in the head and neck squamous cell carcinomas (HNSCC) analyzed by Stransky et al (Stransky N, Egloff A M, Tward A D, Kostic A D, Cibulskis K, Sivachenko A, et al. The mutational landscape of head and neck squamous cell carcinoma. Science 2011; 333:1157-60), most mutated loci were expected to be passenger rather than driver mutations and thus not expected to be subject to direct selection for genomic gain or loss. Consistent with this expectation, among 55 HNSCC with CNA data as shown in Table 2, more than 90% of mutated loci had amplifications within ±0.5 log2 units of normal copy number. Thus, for most loci the correction for normal-cell numbers is close to the correction for normal-cell DNA. MAD and median are robust measures of distribution width and center. MAD and median may not be greatly influenced by small numbers of individual loci. The ratio of MAD and median will be predominantly determined by the large numbers of loci having minimal CNA. Therefore, MATH may be insensitive to the presence of normal cells.

In one configuration, a more detailed correction for normal tissue may be used to correct each locus for its own normal-cell DNA. With population N taken as normal cells (population fraction p_{N}; m_{iN}=0 and c_{iN}=2 for all autosomal loci), multiplying the mutant-allele fraction of locus i by aᵢ/(aᵢ−p_{N}) corrects for normal DNA, providing a cancer-DNA-specific mutant-allele fraction as Equation 3:

$$\frac{{a}_{i}}{{a}_{i} - {p}_{N}} {f}_{i} = \frac{1}{2 ( {a}_{i} - {p}_{N} )} {\sum }_{j = 1}^{N - 1} {m}_{ij} {p}_{j} = {\sum }_{j = 1}^{N - 1} {m}_{ij} {p}_{j} / {\sum }_{j = 1}^{N - 1} {c}_{ij} {p}_{j} \qquad ( 3 )$$

In one embodiment, the correction for normal-cell DNA at most individual loci may be very close to the general correction factor 1/(1−p_{N}) for normal-cell numbers. On the basis of the CNA data provided by Stransky et al (Stransky N, Egloff A M, Tward A D, Kostic A D, Cibulskis K, Sivachenko A, et al. The mutational landscape of head and neck squamous cell carcinoma. Science 2011; 333:1157-60), at a typical 20% normal-cell admixture the correction for normal-cell DNA would be within 10% of the correction for normal-cell numbers for 92% of loci. Even at the maximum acceptable 30% normal cells, the 2 corrections were within 20% for 94% of loci.

Regarding the small differences between the 2 types of correction for normal tissue, the binomial sampling error in determining mutant-allele fractions may be generally 10% to 30%. For example, at 100 sequence reads per locus, typical in these data, the coefficient of variation (CV) for mutant-allele fractions arising from binomial sampling of mutant versus reference alleles was 10%, 20% or 30% at mutant-allele fractions of 0.5, 0.2, or 0.1, respectively. The percentage difference between the 2 types of correction for normal tissue at a locus is almost always less than the percentage CV in measuring its mutant-allele fraction-at 20% normal tissue, for over 96% of loci in the 55 HNSCC with CNA data.

In one configuration, alternative methods may be used to handle CNA. In one specific embodiment, the present MATH calculations may be performed before or after loci having high CNA, such as those more than ±0.5 log2 units away from normal copy number, were removed. The removed loci were those having corrections for normal cell DNA that were farthest from the correction for normal-cell number.

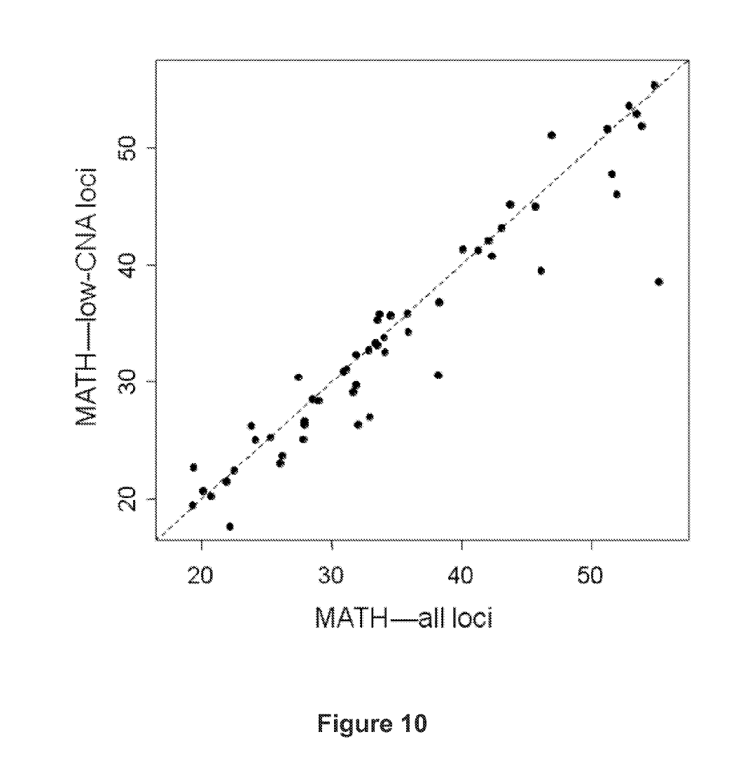

As shown in FIG. 10, Applicants found that most MATH values based only on loci having low CNA were close to the values calculated for all mutated loci, typically within the range of resampling SDs of MATH values. The tumors showing the larger discrepancies had the larger numbers of mutated loci outside these CNA limits.

In another specific embodiment, the mutant-allele fraction of each locus may be first multiplied by its amplification a, to provide a CNA-adjusted mutant-allele fraction, and 100*(MAD/median) for the distribution of CNA-adjusted mutant-allele fractions for each tumor may be calculated. Each CNA-adjusted mutant-allele fraction is then ½ of the average number of mutant copies of the locus per cell. In this embodiment, the adjustment for normal tissue is 1/(1−p_{N}) for all loci, and the correction for normal tissue in the ratio MAD/median is exact.

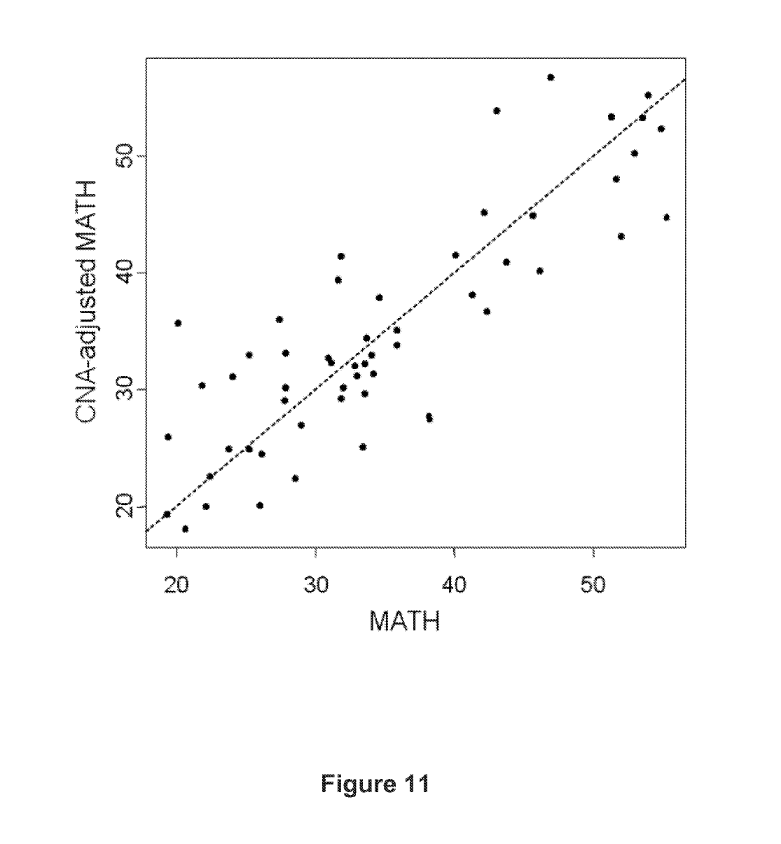

As shown in FIG. 11, the CNA-adjusted MATH values may be similar to MATH values based directly on mutant-allele fractions. Applicants found that neither of these two “corrections” of MATH for CNA, such as omitting high-CNA loci or adjusting for local amplification, has a major effect on MATH values, at least for these combinations of CNA, normal tissue, and mutant-allele fractions.

In one configuration, the present MATH calculation may provide the most straightforward way for now to assess, from NGS results, a type of intratumor heterogeneity that appears to be clinically significant in cancers, such as HNSCC. The present MATH calculation may not require separate analysis of CNA or imputation of CNA from numbers of sequence reads.

As shown in Table 2, Applicants examined the relations of MATH and 5 other potential measures of genomic diversity or instability to 3 clinically important HNSCC variables including disruptive TP53 mutations (versus all other TP53 status), HPV status (in wild-type TP53 cases), and pack-years (among HPV-negative cigarette smokers, taking disruptive TP53 into account). For each tumor, measures considered include MATH as calculated using Equation 1; the number of mutated loci (a measure of overall mutation rate); number of genomic segments showing substantial CNA (segments longer than 1000 base pairs beyond ±0.5 log2 units from normal copy number); mean-square CNA per base (estimate of overall genomic copy-number diversity); MATH restricted to loci with low CNA (FIG. 10); and “CNA-adjusted” MATH, on the basis of mutant-allele fractions multiplied by locus amplification (FIG. 11).

TABLE 2
Relations of measures of genomic instability or lntratumor heterogeneity to clinically
important HNSCC variables, in cases having CNA data for mutated loci.

| | | | p-value for relation of measure to variable | | | | | |
|---|---|---|---|---|---|---|---|---|
| | | | No. of | CNA, | CNA, | MATH, | CNA- | MATH |
| Variable | Number | | mutated | segment | mean- | low CNA | adjusted | (Equation |
| examined | of cases | Test | loci | numbers | square | loci | MATH | 1) |
| Disruptive | 55 | Wilcoxon | 0.26 | 0.13 | 0.002 | 0.056 | 0.020 | 0.024 |
| TP53 | | rank-sum | | | | | | |
| mutation | | | | | | | | |
| HPV | 13 HPV− | Wilcoxon | 0.20 | 0.59 | 0.94 | 0.037 | 0.024 | 0.024 |
| status in | 7 HPV+ | rank-sum | | | | | | |
| wild-type | | | | | | | | |
| TP53 | | | | | | | | |
| Pack- | 41 | t-test for | 0.46* | 0.40* | 0.58* | 0.015 | 0.082 | 0.048 |
| years in | | pack-year | | | | | | |
| HPV- | | coefficient | | | | | | |
| negative | | in bivariate | | | | | | |
| cigarette | | model with | | | | | | |
| smokers | | disruptive | | | | | | |
| | | TP53 | | | | | | |

*These three measures were log transformed for the bivariate model.

As shown in Table 2, neither mutation rate nor the number of segments with substantial CNA was significantly related to these clinical variables in these 55 cases. Overall genomic copy-number variability (mean-square CNA) was related to disruptive TP53 mutation but not to HPV status or to pack-years. As expected from FIGS. 10 and 11, both types of “correction” of MATH for CNA provided relations to these 3 clinical variables close to those seen for MATH based solely on mutant-allele fractions; each of the “corrected” versions slightly missed significance at p<0.05 with respect to one of the clinical variables. For these data, none of the other measures performed better overall with respect to the 3 clinical variables than did MATH, as calculated using Equation 1 directly from mutant-allele fractions (with its implicit inclusion of CNA). MATH calculated in the above method may not require separate analysis of CNA or imputation of CNA from numbers of sequence reads, so the above method provides the most straightforward way for now to assess, from NGS results, a type of intratumor heterogeneity that appears to be clinically significant in HNSCC. Applicants envision that incorporation of information on CNA should be re-assessed in future work on the relations of MATH to outcome in HNSCC and other types of cancer, in larger data sets.

In one configuration of the present invention, the median and the median absolute deviation (MAD), rather than the mean and the standard deviation (SD), may be used as robust measures of the center and the width of each tumor's distribution of mutant-allele fractions.

Mean mutant-allele fraction. Based on Equation 2, the mean mutant-allele fraction over all L mutated loci in N cell populations, mean(f), is shown as Equation 4:

$$mean ( f ) = \frac{{\sum }_{i = 1}^{L} \frac{1}{{a}_{i}} {\sum }_{j = 1}^{N} {m}_{ij} {p}_{j}}{2 L} \qquad ( 4 )$$

wherein the numerator is related to the average number of mutations per cell, with each locus i scaled by its overall amplification aᵢ. The denominator is 2 times the total number of mutated loci among all cancer cell populations.

If there are N cell populations, at least one population must have a cell fraction no greater than 1/N. In particular, heterozygous mutations (without CNA) specific to the smallest population will have mutant-allele fractions no greater than 1/(2N). Thus, increasing numbers of cell populations may tend to shift the mean of the distribution toward lower values, although details depend on the specific patterns of mutation sharing among populations, locus amplification, and cell-population fractions. Even if all N populations are similar in size and do not share mutations so that the width of the distribution is small, the center of the distribution of mutant-allele fractions may thus tend to be lower than for a homogeneous tumor and the ratio of width to center will be higher.

SD of mutant-allele fractions. Mutation sharing among cell populations and differences among cell-population fractions in a tumor increase the SD of the distribution of mutant-allele fractions among loci. Use matrix notation for the (column) vector of mutant-allele fractions F formed from the individual locus values, fᵢ (Equation 2).

$$F = \frac{1}{2} Diag ( 1 / a ) MP \qquad ( 5 )$$

wherein P is the (N×1) vector of cell-population fractions, M is the (L×N) mutation-number matrix (mᵢⱼ=mutant copies of locus i per cell in population j), and Diag(1/a) is a diagonal (L×L) matrix with reciprocals of the locus amplifications along the diagonal.

The variance (square of the SD) of mutant-allele fractions among loci is shown in Equation 6:

$$var ( f ) = \frac{{\sum }_{i = 1}^{L} {f}_{l}^{2}}{L} - {( mean ( f ) )}^{2} = \frac{{F}^{T} F}{L} - {( mean ( f ) )}^{2} = \frac{{P}^{T} ( {M}^{T} Diag ( 1 / {a}^{2} ) M ) P}{4 L} - {( mean ( f ) )}^{2} \qquad ( 6 )$$

wherein the superscript ^{T} represents the transpose. The matrix product M^{T}Diag(1/a²)M is an (N×N) matrix that represents the pattern of mutation sharing among the N cell populations. Elements j, k of M^{T}Diag(1/a²)M are a weighted sum of mutations shared between cell populations j and k, with locus i weighted by (mᵢⱼ mᵢₖ)/(aᵢ)². With heterozygous mutations and without CNA, elements j, k of M^{T}Diag(1/a²)M are simply the total number of mutations shared by populations j and k.

For a tumor having a given mean mutant-allele fraction mean(f), the distribution of mutant-allele fractions among loci may be wide due to mutation sharing among cell populations (non-zero off-diagonal elements of M^{T}Diag(1/a²)M) or variation among cell-population fractions (even in the unlikely event that no populations share any mutations). Insofar as a larger number of cell populations lowers mean(f), the SD is also increased.

The median and the median absolute deviation (MAD) may be used to minimize the influence of the small numbers of mutated loci that have very high mutant-allele fractions. For example, about 5% of loci in the data of Stransky et al (Stransky N, Egloff A M, Tward A D, Kostic A D, Cibulskis K, Sivachenko A, et al. The mutational landscape of head and neck squamous cell carcinoma. Science 2011; 333:1157-60) had mutant-allele fractions greater than ½, versus a median mutant-allele fraction of 0.21 and a mean of 0.25. Many loci with such high mutant-allele fractions represent mutations that are present in almost all cells of a tumor with CNA favoring the mutant allele. Among the 55 HNSCC with CNA data, over 20% of these high mutant-allele loci had copy numbers beyond ±0.5 log2 units of normal, corresponding to high differences between the corrections for normal-cell number and for normal-cell DNA. Such loci widen the distribution of mutant-allele fractions even for a homogeneous tumor. Furthermore, the root-mean-square calculation for SD would highly weight these few loci with high mutant-allele fractions, potentially masking heterogeneity arising from small cell populations.

In contrast, the MAD in the present invention is based on the half of loci closest to the median mutant-allele fraction. Therefore, the exact values both of the loci with the highest mutant-allele fractions and of the loci with the lowest fractions, where binomial sampling error of mutant-allele fractions is greatest, do not matter. Corrections for normal-cell numbers appear identical in both MAD and median values, canceling in their ratio. The MAD and median, and their ratio used to calculate MATH, thus incorporate information about the existence of loci having high or low mutant-allele fractions, without being unduly influenced by the specific values of the outlier loci or the presence of normal cells in a tumor.

In one configuration, the present invention may use any suitable cutoff value of mutant-allele fractions in calculating MATH and measuring distribution of mutant -allele fractions. For example, there had been no previously reported mutations at mutant-allele fractions less than 0.075. Therefore, in one example, Applicants only considered mutations having mutant-allele fractions at least 0.075. As shown in different configurations of the present invention, different choices of cutoff values for low-mutant-allele-fraction may influence relations to outcome. Further, as technology improves, mutations occurring at lower fractions may become detectable. Therefore, the present invention may also enclose the embodiments where that use of a cutoff, such as potentially different choices of a cutoff value, constitutes a modification to or an alternative form of the present algorithm.

Returning to FIG. 2, after calculation of MATH and measurement of distribution of mutant-allele fractions, a report of intra-tumor heterogeneity for the examined tumor is generated (S205). As previously discussed, the report of intra-tumor heterogeneity may include the calculated MATH values, where the larger the MATH values, the higher the intra-tumor heterogeneity. The report of intra-tumor heterogeneity may also include a distribution of mutant-allele fractions among tumor-specific mutated loci of the tumor, where the wider the distribution, the higher the intra-tumor heterogeneity. Further, the report may also include information for evaluating relations of intra-tumor genetic heterogeneity to outcomes of the examined cancer. FIGS. 6-9 demonstrate a few of such examples.

Although HNSCC was used as an example, the computer systems and methods for measuring intra-tumor heterogeneity in the present invention are not specific to HNSCC. The present invention may also be applicable to any other cancers. MATH and distribution of mutant-allele fractions in the present invention may be used as a candidate biomarker in any suitable clinical studies or trials. The present invention may provide a simple, quantitative, and clinically-practical biomarker to help evaluate relations of intra-tumor genetic heterogeneity to outcome in any type of cancer. Applicants envision that translational research that combines analysis of MATH with studies on mechanisms of intratumor heterogeneity may provide methods of clinical strategies for specifically targeting heterogeneous tumors.

The present invention has been described in terms of one or more preferred embodiments, and it should be appreciated that many equivalents, alternatives, variations, and modifications, aside from those expressly stated, are possible and within the scope of the invention.

We claim:

1. A computer system for measuring intra-tumor heterogeneity, the computer system programmed to:
a. obtain genetic information of a tumor,
b. indentify genetic information of mutation specific to the tumor,
c. determine a mutant-allele fraction for each mutated locus,
d. calculate mutant-allele tumor heterogeneity (MATH) and measure a distribution of mutant-allele fractions among tumor-specific mutated loci of the tumor, and
e. generate report of intra-tumor heterogeneity for the tumor.

2. The computer system of claim 1, wherein the genetic information is a DNA sequence.

3. The computer system of claim 2, wherein the DNA sequence is obtained from next-generation sequencing (NGS).

4. The computer system of claim 1, wherein steps b and c are determined from next-generation sequencing (NGS).

5. The computer system of claim 1, wherein the MATH and distribution of mutant-allele fractions are determined by:
MATH=100*MAD/median;
wherein MAD means median absolute deviation showing a measurement of distribution width, and median means a median of mutant-allele fractions showing a measurement of distribution center.

6. The computer system of claim 1, wherein the computer system comprises an input interface unit, a processor, a display device, a random access memory (RAM) unit, a read-only memory (ROM) unit, a communication interface, and a driving unit.

7. The computer system of claim 1, wherein during step d the additional information of copy-number alteration (CNA) is further used.

8. A method for measuring intra-tumor heterogeneity comprising the steps of:
a. obtain pre-determined genetic information of a tumor,
b. indentify genetic information of mutation specific to the tumor,
c. determine a mutant-allele fraction for each mutated locus,
d. calculate mutant-allele tumor heterogeneity (MATH) and measure a distribution of mutant-allele fractions among tumor-specific mutated loci of the tumor, and
e. generate report of intra-tumor heterogeneity for the tumor.

9. The method of claim 8, wherein the pre-determined genetic information is a DNA sequence.

10. The method of claim 8, wherein the DNA sequences are obtained from next-generation sequencing (NGS).

11. The method of claim 8, wherein steps b and c are determined from next-generation sequencing (NGS).

12. The method of claim 8, wherein the MATH and distribution of mutant-allele fractions are determined by:
MATH=100*MAD/median;
wherein MAD means a median absolute deviation showing a measurement of distribution width, and median means a median of mutant-allele fractions showing a measurement of distribution center.

13. The method of claim 8, wherein during step d the additional information of copy-number alteration (CNA) is further used.

14. A computer system for measuring intra-tumor heterogeneity, the computer system comprising:
a) an input interface unit to obtain genetic information of a tumor,
b) a non-transitory, computer-readable storage medium having stored thereon instructions that, when executed by a processor, cause the processor to carry out steps including:
i) indentify genetic information of mutation specific to the tumor,
ii) determine the mutant-allele fraction for each mutated locus, and
iii) calculate mutant-allele tumor heterogeneity (MATH) of the tumor, and
c) a display to generate report of intra-tumor heterogeneity for the tumor at least indicating the MATH of the tumor.

15. The computer system of claim 14, wherein the computer system further comprises a communication interface to obtain genetic information of a tumor.

16. The computer system of claim 14, wherein the processor is further caused to measure a distribution of mutant-allele fractions among tumor-specific mutated loci of the tumor and the report indicates the distribution.
